(19) United States
(12) Patent Application Publication
(10) Pub. No.: US 2016/0264280 A1
(43) Pub. Date: Sep. 15, 2016

(54) Sticker Dispensing Assembly

(71) Applicant: Frank Giles, Lakeland, FL (US)

(72) Inventor: Frank Giles, Lakeland, FL (US)

(21) Appl. No.: 14/657,298

(22) Filed: Mar. 13, 2015

(51) Int. Cl. B65C 9/18

(52) U.S. Cl. CPC B65C 9/18

(57) ABSTRACT

A sticker dispensing assembly for includes a housing that has a front wall, a back wall and a peripheral wall extending between the front wall and the back wall. A dispensing unit is positioned within the housing and the dispensing unit contains a plurality of stickers. The dispensing unit selectively dispenses a selected one of the stickers.

### BACKGROUND OF THE DISCLOSURE

### Field of the Disclosure

The disclosure relates to sticker dispensing devices and more particularly pertains to a new sticker dispensing device for dispensing stickers used to non-verbally communicate an emotional state of an individual.

### SUMMARY OF THE DISCLOSURE

An embodiment of the disclosure meets the needs presented above by generally comprising a housing that has a front wall, a back wall and a peripheral wall extending between the front wall and the back wall. A dispensing unit is positioned within the housing and the dispensing unit contains a plurality of stickers. The dispensing unit selectively dispenses a selected one of the stickers.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a sticker dispensing assembly according to an embodiment of the disclosure.

FIG. 2 is a back view of an embodiment of the disclosure.

FIG. 3 is a front view of an embodiment of the disclosure.

FIG. 4 is a left side view of an embodiment of the disclosure.

FIG. 5 is a right side phantom view of an embodiment of the disclosure.

FIG. 6 is a front perspective view of an embodiment of the disclosure.

### DESCRIPTION OF THE PREFERRED EMBODIMENT

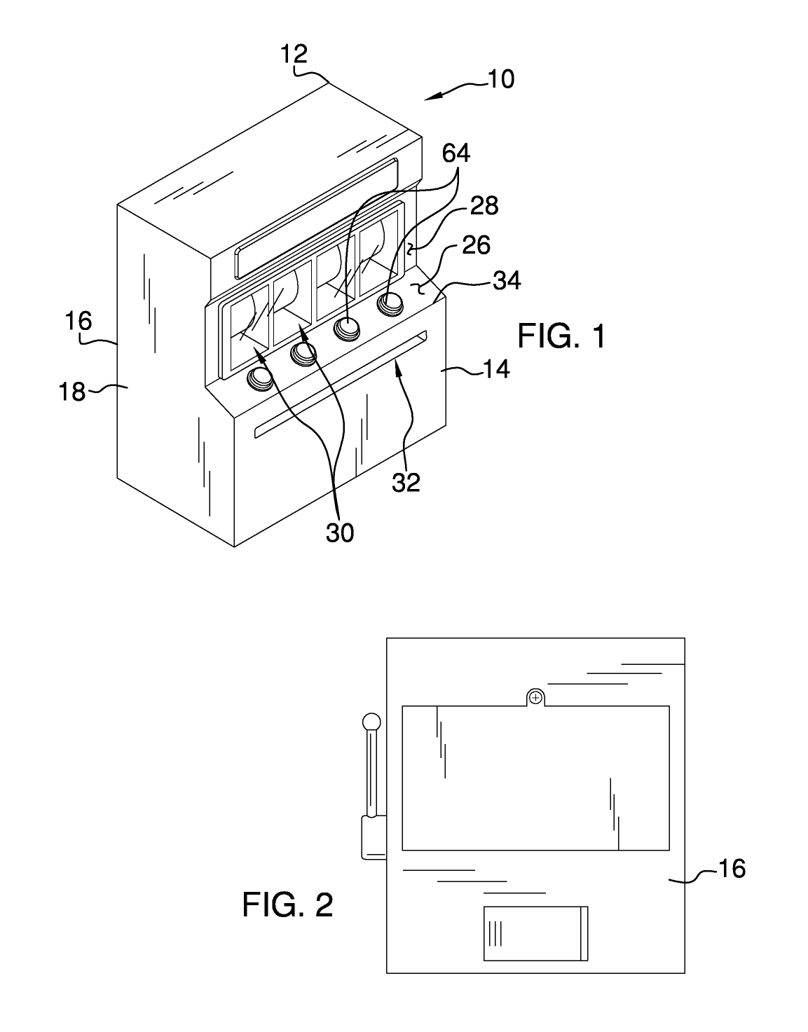

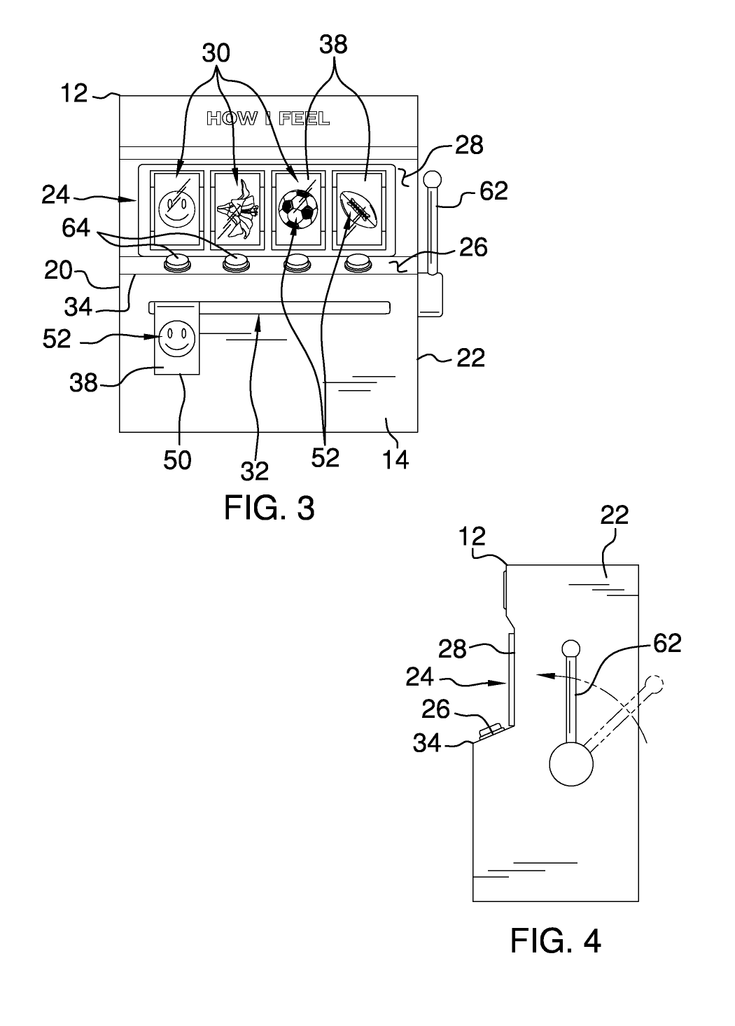

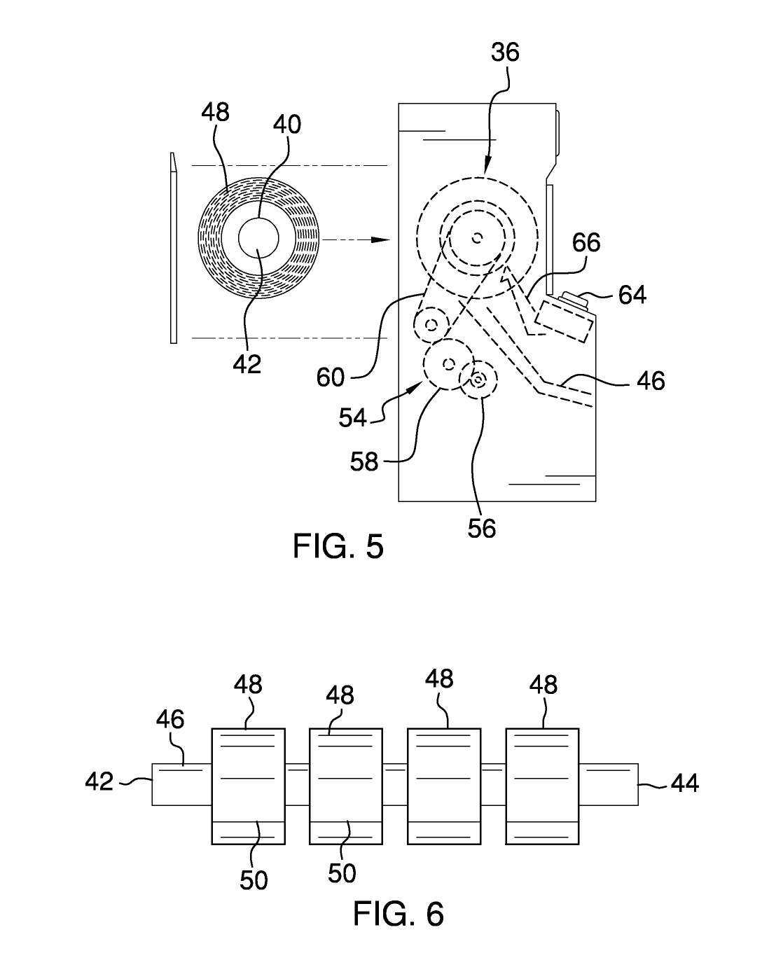

With reference now to the drawings, and in particular to FIGS. 1 through 6 thereof, a new sticker dispensing device embodying the principles and concepts of an embodiment of the disclosure and generally designated by the reference numeral 10 will be described.

As best illustrated in FIGS. 1 through 6, the sticker dispensing assembly 10 generally comprises a housing 12 that has a front wall 14, a back wall 16 and a peripheral wall 18 extending between the front wall 14 and the back wall 16, and the peripheral wall 18 has a first lateral side 20 and a second lateral side 22. The front wall 14 has a recessed portion 24 and a lower bounding surface 26 of the recessed portion 24 slopes downwardly from a rear bounding surface 28 of the recessed portion 24. The rear bounding surface 28 has a plurality of openings 30 extending therethrough and the openings 30 are spaced apart from each other and distributed between the first lateral side 20 and the second lateral side 22. The front wall 14 has a slot 32 extending therethrough and the slot 32 extends between the first lateral side 20 and the second lateral side 22. The slot 32 is positioned adjacent to a lower threshold 34 of the lower bounding surface 26. The housing 12 may be structured to resemble a slot machine or the like.

A dispensing unit 36 is positioned within the housing 12 and the dispensing unit 36 contains a plurality of stickers 38. The dispensing unit 36 selectively dispenses a selected one of the stickers 38. The dispensing unit 36 comprises a spool 40 that has a first end 42 and a second end 44 and the spool 40 is removably positioned within the housing 12. The first end 42 of the spool 40 is rotatably coupled to the first lateral side 20 and the second end 44 of the spool 40 is rotatably coupled to the second lateral side 22 when the spool 40 is positioned within the housing 12. The spool 40 is aligned with the openings 30 when the spool 40 is positioned within the housing 12. A chute 46 is positioned within the housing 12 and the chute 46 extends between the spool 40 and the slot 32.

A plurality of strips 48 is provided and each of the strips 48 is rolled around the spool 40. Each of the strips 48 has a free end 50 with respect to the spool 40 and the free end 50 of each of the strips 48 is drawable off of the spool 40. Each of the strips 48 is spaced apart from each other and distributed between the first end 42 and the second end 44 of the spool 40. Each of the strips 48 is visible through one of the openings 30 and each of the strips has the plurality of stickers 38 removably adhered thereto. Each of the stickers 38 on one of the strips 48 has a unique image 52 printed thereon with respect to the stickers 38 on remaining ones of the strips 48. The image 52 on each of the stickers 38 may be an image to communicate an emotional state of an individual such as a smiley face, a frowning face or the like.

A drive 54 is positioned within the housing 12 and the drive 54 is in mechanical communication with the spool 40 whereby the drive selectively rotates the spool 40. The drive 54 comprises a motor 56 positioned within the housing 12. A gear 58 is positioned within the housing 12 and the gear 58 engages the motor 56 such that motor 56 rotates the gear 58 when the motor 56 is turned on. The motor 56 may be an electrical motor or the like. A belt 60 extends around the gear 58 and the spool 40, and the belt 60 rotates the spool 40 when the motor 56 is turned on.

A handle 62 is movably coupled to the second lateral side 22 of the housing 12. The handle 62 is urgeable into an actuating positioned to turn the motor 56 on and the handle 62 is biased into a de-actuating position after the handle 62 is urged into the actuating position. A plurality of buttons 64 is coupled to the lower bounding surface 26 of the recessed portion 24 and each of the buttons 64 is aligned with one of the openings 30.

A plurality of locks 66 is positioned within the housing 12 and each of the locks 66 are electrically coupled to one of the buttons 64. Each of the locks 66 is biased into a locking position such that each of the locks 66 engages an associated one of the strips 48 whereby the associated strip 48 is prevented from rotating when the motor 56 rotates the spool 40. Each of the locks 66 is actautable in an unlocking position when an associated one of the buttons 64 is engaged such that an unlocked one of the strips 48 is allowed to rotate when the motor 56 is turned on. The free end 50 of the unlocked strip 48 is directed through the chute 46 and outwardly from the slot 32 such that one of the stickers 38 is removable from the unlocked strip 48.

In use, the stickers 38 are viewed through the openings 30 and one of the stickers 48 is chosen based on the image 52 on the sticker 38. The button 64 is engaged that corresponds to the strip 48 on which the sticker 38 is positioned. The handle 62 is urged into the actuating position so the motor 56 rotates the unlocked strip 48 to dispense the sticker 48 from the chute 46. The sticker 38 is removed from the strip 48 and the sticker 38 is worn. The sticker 38 serves as a non-verbal means of communicating the emotional state of the individual.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sticker dispensing assembly configured to selectively dispense a sticker to communicate a physical state of a user, said assembly comprising:
a housing having a front wall, a back wall and a peripheral wall extending between said front wall and said back wall; and
a dispensing unit positioned within said housing, said dispensing unit containing a plurality of stickers, said dispensing unit selectively dispensing a selected one of said stickers.

2. The assembly according to claim 1, wherein said peripheral wall has a first lateral side and a second lateral side, said front wall having a recessed portion, a lower bounding surface of said recessed portion sloping downwardly from a rear bounding surface of said recessed portion, said rear bounding surface having a plurality of openings extending therethrough, said openings being spaced apart from each other and distributed between said first lateral side and said second lateral side.

3. The assembly according to claim 2, wherein said front wall has a slot extending therethrough, said slot extending between said first lateral side and said second lateral side, said slot being positioned adjacent to a lower threshold of said lower bounding surface.

4. The assembly according to claim 1, wherein:
said housing has a first lateral side and a second lateral side, said housing having a plurality of openings and a slot; and
said dispensing unit comprises a spool having a first end and a second end, said spool being removably positioned within said housing, said first end of said spool being rotatably coupled to said first lateral side and said second end of said spool being rotatably coupled to said second lateral side when said spool is positioned within said housing, said spool being aligned with said openings when said spool is positioned within said housing.

5. The assembly according to claim 4, further comprising a chute positioned within said housing, said chute extending between said spool and said slot.

6. The assembly according to claim 5, further comprising a plurality of strips, each of said strips being rolled around said spool, each of said strips having a free end with respect to said spool, said free end of each of said strips being drawable off of said spool, each of said strips being spaced apart from each other and distributed between said first end and said second end of said spool.

7. The assembly according to claim 6, wherein each of said strips is visible through one of said openings, each of said strips having a plurality of stickers removably adhered thereto, each of said stickers on one of said strips having a unique image printed thereon with respect to said stickers on remaining ones of said strips.

8. The assembly according to claim 1, further comprising:
a spool; and
a drive positioned within said housing, said drive being in mechanical communication with said spool whereby said drive selectively rotates said spool.

9. The assembly according to claim 8, wherein said drive comprises a motor positioned within said housing, a gear positioned within said housing, said gear engaging said motor such that motor rotates said gear when said motor is turned on.

10. The assembly according to claim 9, further comprising:
said housing having a second lateral side; and
a handle movably coupled to said second lateral side, said handle being urgeable into an actuating positioned to turn said motor on, said handle being biased into a de-actuating position after said handle is urged into said actuating position.

11. The assembly according to claim 10, further comprising:
said housing having a recessed portion, said recessed portion having a lower bounding surface;
said housing having a plurality of openings; and
a plurality of buttons coupled to said lower bounding surface of said recessed portion, each of said buttons being aligned with one of said openings.

12. The assembly according to claim 11, wherein a plurality of locks positioned within said housing, each of said lock being electrically coupled to one of said buttons, each of said locks being biased into a locking position such that each of said locks engages an associated one of said strips whereby said associated strip is prevented from rotating when said motor rotates said spool, each of said locks being actautable in an unlocking position when an associated one of said buttons is engaged such that an unlocked one of said strips is allowed to rotate when said motor is turned on, said free end of said unlocked strip being directed through said chute and outwardly from said slot such that one of said stickers is removable from said unlocked strip.

13. A sticker dispensing assembly configured to selectively dispense a sticker to communicate a physical state of a user, said assembly comprising:
a housing having a front wall, a back wall and a peripheral wall extending between said front wall and said back wall, said peripheral wall having a first lateral side and a second lateral side, said front wall having a recessed portion, a lower bounding surface of said recessed portion sloping downwardly from a rear bounding surface of said recessed portion, said rear bounding surface having a plurality of openings extending therethrough, said openings being spaced apart from each other and distributed between said first lateral side and said second lateral side, said front wall having a slot extending therethrough, said slot extending between said first lateral side and said second lateral side, said slot being positioned adjacent to a lower threshold of said lower bounding surface;
a dispensing unit positioned within said housing, said dispensing unit containing a plurality of stickers, said dispensing unit selectively dispensing a selected one of said stickers, said dispensing unit comprising:
a spool having a first end and a second end, said spool being removably positioned within said housing, said first end of said spool being rotatably coupled to said first lateral side and said second end of said spool being rotatably coupled to said second lateral side when said spool is positioned within said housing, said spool being aligned with said openings when said spool is positioned within said housing;
a chute positioned within said housing, said chute extending between said spool and said slot; and
a plurality of strips, each of said strips being rolled around said spool, each of said strips having a free end with respect to said spool, said free end of each of said strips being drawable off of said spool, each of said strips being spaced apart from each other and distributed between said first end and said second end of said spool, each of said strips being visible through one of said openings, each of said strips having a plurality of stickers removably adhered thereto, each of said stickers on one of said strips having a unique image printed thereon with respect to said stickers on remaining ones of said strips; and
a drive positioned within said housing, said drive being in mechanical communication with said spool whereby said drive selectively rotates said spool, said drive comprising:
a motor positioned within said housing;
a gear positioned within said housing, said gear engaging said motor such that motor rotates said gear when said motor is turned on;
a belt extending around said gear and said spool, said belt rotating said spool when said motor is turned on;
a handle movably coupled to said second lateral side, said handle being urgeable into an actuating positioned to turn said motor on, said handle being biased into a de-actuating position after said handle is urged into said actuating position;
a plurality of buttons coupled to said lower bounding surface of said recessed portion, each of said buttons being aligned with one of said openings; and
a plurality of locks positioned within said housing, each of said lock being electrically coupled to one of said buttons, each of said locks being biased into a locking position such that each of said locks engages an associated one of said strips whereby said associated strip is prevented from rotating when said motor rotates said spool, each of said locks being actautable in an unlocking position when an associated one of said buttons is engaged such that an unlocked one of said strips is allowed to rotate when said motor is turned on, said free end of said unlocked strip being directed through said chute and outwardly from said slot such that one of said stickers is removable from said unlocked strip.
